(19) United States
(12) Patent Application Publication
(10) Pub. No.: US 2025/0311077 A1
(43) Pub. Date: Oct. 2, 2025

(54) SOLID-STATE CIRCUIT BREAKER LIGHT DIMMER

(71) Applicant: Siemens Industry, Inc., Alpharetta, GA (US)

(72) Inventor: Kevin Miller, Duluth, GA (US)

(73) Assignee: Siemens Industry, Inc., Alpharetta, GA (US)

(21) Appl. No.: 18/617,850

(22) Filed: Mar. 27, 2024

(51) Int. Cl. H05B 47/155; H05B 47/19

(52) U.S. Cl. CPC H05B 47/155; H05B 47/19

(57) ABSTRACT

A solid-state circuit breaker is provided. The solid-state circuit breaker includes a breaker housing, a line-in terminal, and a line-out terminal, and one or more solid-state switching components configured between the line-in terminal and the line-out terminal. The solid-state circuit breaker also includes an air gap disposed between the line-in terminal and the line-out terminal that is coupled in series with the one or more solid-state switching components to complete a current conducting path when closed. The solid-state circuit breaker further includes an air gap actuator to interact with the air gap driving mechanism, a transceiver, and a controller that controls the air gap actuator and the one or more solid-state switching components. The controller is configured to receive a command signal and to responsively control the one or more solid-state switching components based on the command signal.

### BACKGROUND

Aspects of the present invention generally relate to solid-state circuit breakers and more specifically to solid-state circuit breakers configured to act as dimmer switches.

In general, a solid-state circuit breaker is a circuit breaker that includes semiconductor devices and algorithms that are configured to control the flow of power through the circuit breaker. Existing solid-state circuit breakers have only two operational states, on and off, that are used to protect a load from overcurrent. Similar to traditional circuit breakers, traditional light switches have only two states, on and off. In contrast, a dimmer switch offers a continuous range of control, allowing a user to set the desired light level. Modern dimmer switches work by rapidly turning the power on and off, creating the effect of dimming. Dimmer switches cut power at the exact moment the electrons change direction, which reduces the amount of energy going into the bulb without causing the lights to flicker. Turning the dimmer up or down determines how long the circuit's off, which determines how bright the lights are.

Currently, to dim the lighting in a home, office hallway, or building parking lot, individuals must purchase one or more dimming apparatus to dim the lights. These dimming apparatuses must be installed by placing the dimming apparatus in series with the lighting load, i.e., between the circuit breaker and the lighting loads. Depending on the configuration of the switch(es) connected to the lighting load, installation of the dimming apparatus may be a complex task. In addition, when dimming the lights, an end user must find and activate the dimming apparatus.

### SUMMARY

In accordance with one embodiment of the present invention, a solid-state circuit breaker is provided. The solid-state circuit breaker includes a breaker housing, a line-in terminal, and a line-out terminal, and one or more solid-state switching components configured between the line-in terminal and the line-out terminal. The solid-state circuit breaker also includes an air gap disposed between the line-in terminal and the line-out terminal that is Coupled in series with the one or more solid-state switching components to complete a current conducting path when closed, the air gap including a pair of opposing contacts and an air gap driving mechanism. The solid-state circuit breaker further includes an air gap actuator to interact with the air gap driving mechanism, a transceiver, and a controller that controls the air gap actuator and the one or more solid-state switching components. The controller is configured to receive a command signal and to responsively control the one or more solid-state switching components based on the command signal.

In accordance with one embodiment of the present invention, a method for operating a solid-state circuit breaker is provided. The method includes receiving a command signal indicating a desired output power level of the solid-state circuit breaker, calculating one of a phase angle and a duty cycle corresponding to the desired output power level, and generating a modified output alternating current signal by controlling an operation of one or more solid-state switching components configured between a line-in terminal and a line-out terminal based on the one of the phase angle and the duty cycle of an alternating current signal at the line-in terminal. The command signal is received via a transceiver of the solid-state circuit breaker from a user device that is separate from the solid-state circuit breaker.

In accordance with one embodiment of the present invention, a system having a solid-state circuit breaker is provided. The solid-state circuit breaker solid-state circuit breaker includes a breaker housing, a line-in terminal, and a line-out terminal, and one or more solid-state switching components configured between the line-in terminal and the line-out terminal. The solid-state circuit breaker also includes an air gap disposed between the line-in terminal and the line-out terminal that is coupled in series with the one or more solid-state switching components to complete a current conducting path when closed, the air gap including a pair of opposing contacts and an air gap driving mechanism. The solid-state circuit breaker further includes an air gap actuator to interact with the air gap driving mechanism, a transceiver, and a controller that controls the air gap actuator and the one or more solid-state switching components. The system also includes a load that includes one or more lighting devices connected to the line-out terminal of the solid-state circuit breaker. The command signal is received from a user device that is in communication with the transceiver of the solid-state circuit breaker.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram of a solid-state circuit breaker in accordance with an exemplary embodiment of the present invention;

FIG. 2 is a block diagram of a system having a solid-state circuit breaker in accordance with an exemplary embodiment of the present invention;

FIG. 3 is an illustration of an input signal and output signal of a solid-state circuit breaker in accordance with an exemplary embodiment of the present invention;

FIGS. 4A and 4B are illustrations of output signals of a solid-state circuit breaker in accordance with an exemplary embodiment of the present invention;

FIG. 5 illustrates a flowchart of a method for operating a solid-state circuit breaker in accordance with an exemplary embodiment of the present invention; and

FIGS. 6A and 6B are respectively illustrations of an input signal and an output signal of a solid-state circuit breaker in accordance with an exemplary embodiment of the present invention.

### DETAILED DESCRIPTION

Embodiments of the present invention include a solid-state circuit breaker that is configured to act as a dimmer for a lighting load connected to the solid-state circuit breaker. In exemplary embodiments, the solid-state circuit breaker includes a controller that is configured to control the phase, or the time, at which power is provided to a lighting load connected to the solid-state circuit breaker. For instance, the brightness of the lights connected to the solid-state circuit breaker can be controlled by turning on/off the solid-state circuit breaker momentarily within an alternating current pulse. In other words, the brightness of the lights connected to the solid-state circuit breaker can be controlled by using switching components solid-state circuit breaker to control the duty cycle of the power output by the solid-state circuit breaker.

In exemplary embodiments, the solid-state circuit breaker includes algorithms that are configured to control the operation of one or more switching components of the solid-state circuit breaker to control the power output by the solid-state circuit breaker. The solid-state circuit breaker algorithms incorporate light-dimming functions and can be used instead of the traditional dimming apparatus. In addition, the solid-state circuit breaker includes a transceiver that is configured to receive command signals that indicate a desired output level of the solid-state circuit breaker from one or more external devices.

In general, for traditional lighting, when a lighting load is powered by a sixty Hertz alternating current (AC) power signal no current flows into the lighting load at zero or three hundred and sixty degrees per cycle. Contrary, maximum current flows into the lighting load at ninety degrees or two hundred and seventy degrees per cycle. For the purposes of explanation, the zero to three hundred and sixty-degree cycle of an AC input signal to the lighting loads will be divided up into two lobes, one that spans zero to one hundred and eighty degrees, referred to as the positive lobe, and another that spans one hundred and eighty-one degrees to three hundred and sixty degrees, referred to as the negative lobe amplitude. In exemplary embodiments, the solid-state circuit breaker is configured to selectively turn on/off the current supply to a load. In one embodiment, the phase angle of the input signal is used by the solid-state circuit breaker to control the solid-state switching components of the solid-state circuit breaker. As a result, the solid-state circuit breaker can control output pulses to lighting, like a traditional dimmer switch.

In exemplary embodiments, the solid-state circuit breaker controls the turn-on phase for both the upper and lower lobes of the AC power signal. The solid-state breaker controls (for each positive and negative lobe) the phase current angle for conduction on time for the load. Because the ampere conduction on time (or phase angle) can be controlled the ampere current can be regulated by how long the load can demand current (through phase angles between zero to one hundred and eighty degrees for one lobe). For example, at zero dimming the current ampere conduction start time is at one degree for the load when referencing the phase or x-axis of a sinusoidal current plot. Maximum dimming (no illumination of light) occurs when the phase angle starts closer to one hundred and eighty degrees (per lobe).

To facilitate an understanding of embodiments, principles, and features of the present invention, they are explained hereinafter with reference to implementation in illustrative embodiments. In particular, they are described in the context of a solid-state circuit breaker that includes a controller that operates solid-state switching components to control the power output by the solid-state circuit breaker. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

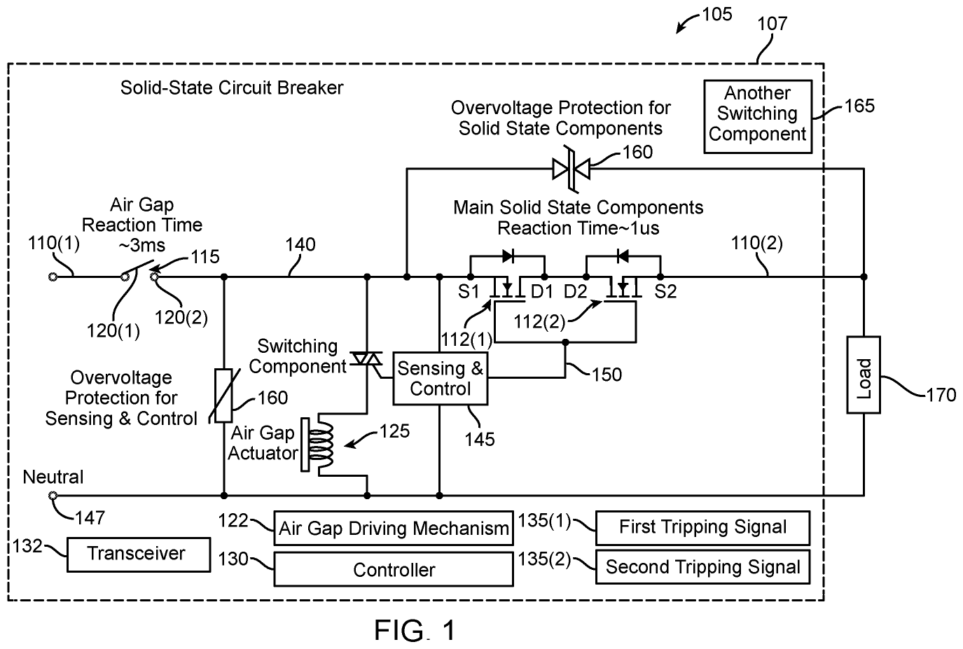

These and other embodiments of the solid-state circuit breaker according to the present disclosure are described below with reference to FIGS. 1-5 herein. Like reference numerals used in the drawings identify similar or identical elements throughout the several views. The drawings are not necessarily drawn to scale.

FIG. 1 illustrates a solid-state circuit breaker 105 in accordance with an exemplary embodiment of the present invention. The solid-state circuit breaker 105 includes a breaker housing 107, a line-in terminal 110-1, a line-out terminal 110-2, and one or more solid-state switching components 112(1-2) configured between the line-in terminal 110-1 and line-out terminal 110-2. The solid-state circuit breaker 105 further includes an air gap 115 disposed between line-in terminal 110-1 and line-out terminal 110-2 and coupled in series with one or more solid-state switching components 112(1-2) to complete a current conducting path when closed. The air gap 115 includes a pair of opposing contacts 120(1-2) and an air gap driving mechanism 122.

The solid-state circuit breaker 105 also includes an air gap actuator 125 that is configured to interact with the air gap driving mechanism 122. In exemplary embodiments, the solid-state circuit breaker 105 includes a controller 130, which is one of a general-purpose processor, a field programmable gate array (FPGA), an application-specific integrated circuit (ASIC), and the like. The controller 130 controls the operation of the air gap actuator 125 and the operation of the one or more solid-state switching components.

In one embodiment, the controller 130 is configured to either send a tripping signal 135(1) to the air gap actuator 125 and the one or more solid-state switching components 112(1-2) at the same time, or send a tripping signal 135(2) to the air gap actuator 125 a short amount of time earlier than sending the tripping signal 135(2) to the one or more solid-state switching components 112(1-2). In one embodiment, the short amount of time is a few milliseconds. The tripping signal 135(1) and the tripping signal 135(2) are the same tripping signal but represent two different scenarios. In both cases of operation of the solid-state circuit breaker 105, the one or more solid-state switching components 112(1-2) still turn OFF first and arcing does not happen when the air gap 115 opens. The air gap 115 can open as close as less than 1 millisecond after the one or more solid-state switching components 112(1-2) are OFF. A solid-state switching component of the one or more solid-state switching components 112(1-2) is a metal-oxide-semiconductor field-effect transistor (MOSFET) or an insulated-gate bipolar transistor (IGBT) which has a short reaction time and can switch OFF quickly in the order of 1 microsecond or less after receiving a trigger signal from the controller 130.

The solid-state circuit breaker 105 also includes a load current carrying path 140 formed by the air gap 115 being placed in series with one or more solid-state switching components 112(1-2). The solid-state circuit breaker 105 also includes a sensing and control circuitry 145 provided across a connection point after the air gap 115 and a neutral 147 to control a gate 150 of the one or more solid-state switching components 112(1-2) and is configured to monitor a load current condition. Depending on functionalities, the controller 130 can decide to trip the solid-state circuit breaker 105 under fault conditions, such as an overload, a short circuit, a ground fault, or an arc fault.

A benefit of turning on the air gap actuator 125 at the same time or earlier than the one or more solid-state switching components 112(1-2) is additional overvoltage protection. If an air gap actuator 125 is open when overvoltage happens it can share current generated by an overvoltage and reduce wear on overvoltage protection components 160. An arrangement of the solid-state circuit breaker 105 can provide additional protection for an overvoltage generated on a line side. To provide more protection for an overvoltage generated on a load side, another actuator switching component 165 can be added to connect to the load side.

In exemplary embodiments, the controller 130 is further configured to control the operation of the one or more solid-state switching components 112(1-2) to control a power level of the output signal on the line-out terminal 110-2 that is provided to the load 170. In exemplary embodiments, the controller 130 receives a command signal from a transceiver 132, which indicates a desired power level to be provided to the load 170. In exemplary embodiments, the transceiver 132 is Configured to communicate with one or more devices external to the solid-state circuit breaker 105 using one or more of Bluetooth, Wi-Fi, Zigbee. or other wireless communication protocols.

In one embodiment, the desired power level is a percentage that ranges from zero to one hundred percent. In one embodiment, the controller 130 is configured to control a duty cycle of the solid-state switching components 112(1-2) based on the desired power level. In one example, if the desired power level is zero, or off, the controller 130 will deactivate the solid-state switching components 112(1-2) such that none of the input power signal received by the line-in terminal 110-1 is provided to the load 170 via the line-out terminal 110-2. In another embodiment, if the desired power level is one hundred percent, the controller 130 will activate the solid-state switching components 112(1-2) such that the entire input power signal received by the line-in terminal 110-1 is provided to the load 170 via the line-out terminal 110-2. In a further embodiment, if the desired power level is fifty percent, the controller 130 will selectively activate the solid-state switching components 112(1-2) such that a portion of the input power signal received by the line-in terminal 110-1 is provided to the load 170 via the line-out terminal 110-2. In exemplary embodiments, the portion of the input power signal that is provided to the line-out terminal 110-2 may be determined by the controller 130 based on a table look-up, interpolation, or other means.

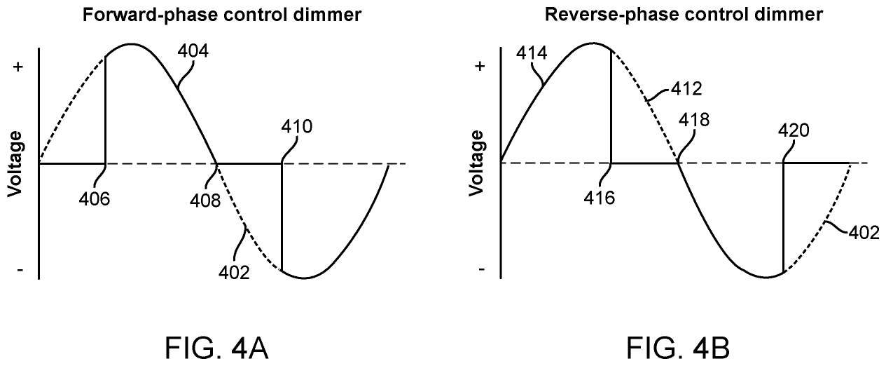

In exemplary embodiments, the controller 130 is configured to control the power level of the power signal provided to the load 170 via the line-out terminal 110-2 based on the phase angle of the input power signal at the line-in terminal 110-1 or based on a time. In one embodiment, controlling the one or more solid-state switching components based on the command signal includes selectively activating and deactivating the one or more solid-state switching components based on a phase angle of an alternating current signal at the line-in terminal 110-1. In exemplary embodiments, the controller 130 is further configured to selectively perform one of a forward-phase dimmer control and a reverse-phase dimmer control using the one or more solid-state switching components 112(1-2), which are discussed in more detail with reference to FIGS. 4A and 4B.

In one embodiment, the load 170 includes one or more lighting apparatuses and the solid-state circuit breaker 105 is configured to act as a dimmer for the one or more lighting apparatuses. In another embodiment, the load 170 includes one or more restive heating apparatuses, and the solid-state circuit breaker 105 is configured to control the operation, i.e., the heating level, of the one or more restive heating apparatuses.

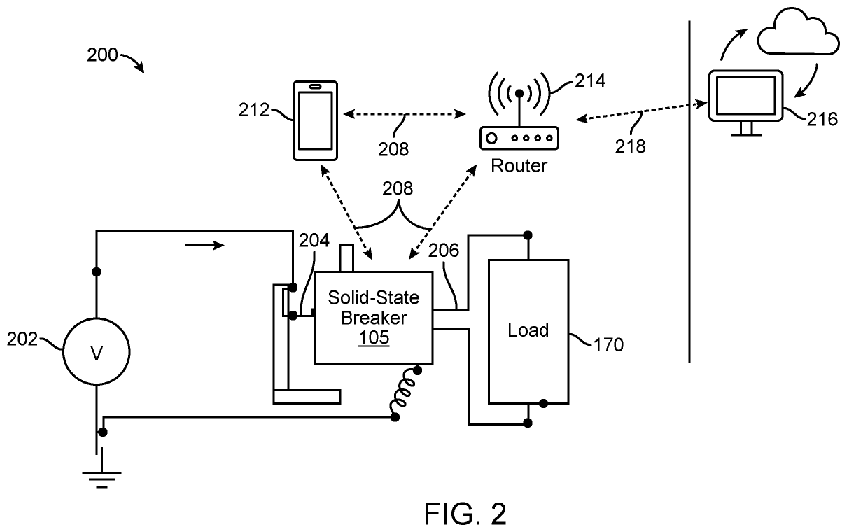

Referring now to FIG. 2, a block diagram of a system 200 having a solid-state circuit breaker 105 in accordance with an exemplary embodiment of the present invention is shown. As illustrated, the system 200 includes a power source 202 that is connected to the solid-state circuit breaker 105 via a first conductor 204. In one embodiment, the power source 202 is an alternating current power source having a frequency of approximately sixty Hertz. The solid-state circuit breaker 105 is connected to a load 170 via a second conductor 206. As discussed above, the load 170 includes one or more lighting apparatus that are configured to be operated by the solid-state circuit breaker 105. In exemplary embodiments, the solid-state circuit breaker 105 is configured to communicate, via the transceiver, via one or more wireless communication links 208 with external devices, such as a user device 212 and/or a communications device 214.

In one embodiment, the user device 212 is a smartphone, tablet, or another personal communication device that is configured to communicate, directly or indirectly, with the solid-state circuit breaker 105. In another embodiment, the user device 212 is a special-purpose device, such as a remote control, that is configured to communicate, directly or indirectly, with the solid-state circuit breaker 105. In exemplary embodiments, the communications device 214 is configured to connect to a computing system 216 via a communications network 218, such as the Internet.

In exemplary embodiments, the user device 212 and/or the computing system 216 include applications that allow a user to control the operation of the solid-state circuit breaker 105. For example, the applications can be used to turn on/off the solid-state circuit breaker 105 and to provide the solid-state circuit breaker 105 with a command signal that indicates a desired power level, or desired brightness, for the load 170. Furthermore, the applications can be used to program the controller of the solid-state circuit breaker 105.

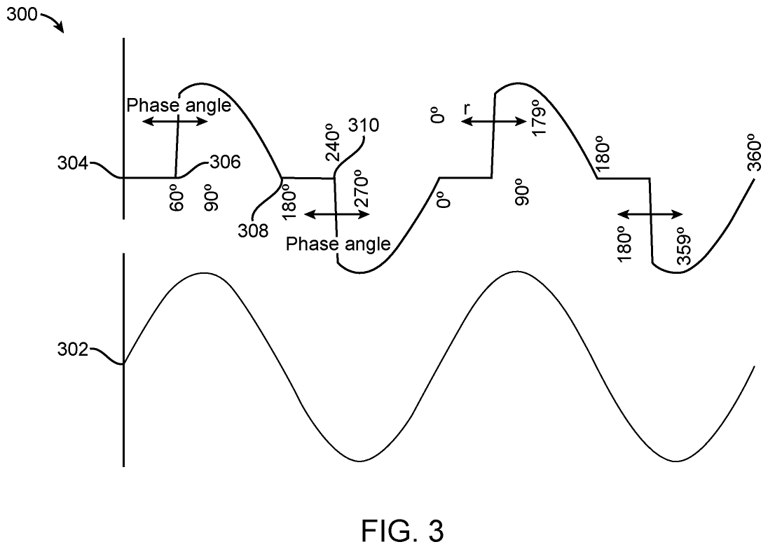

Referring now to FIG. 3, an illustration of an input signal 302 and output signal 304 of a solid-state circuit breaker in accordance with an exemplary embodiment of the present invention is shown. As illustrated, the input signal 302 is an alternating current (AC) signal and the output signal 304 is a modified AC signal that has been created by the solid-state circuit breaker based on the input signal 302. In the illustrated example, the output signal 304 is created by turning on the switching the solid-state switching components when the phase angle of the input signal 302 reaches a first phase angle 306, sixty degrees in the illustrated example, turning off the solid-state switching components, when the phase angle of the input signal 302 reaches a second phase angle 308, one-hundred and eighty degrees in the illustrated example, and turning on the switching the solid-state switching components when the phase angle of the input signal 302 reaches a third phase angle 310, two-hundred and forty degrees in the illustrated example. In exemplary embodiments, the values of the first phase angle 306, the second phase angle 308, and the third phase angle 310 are determined by the controller of the solid-state circuit breaker based on the desired output level of the solid-state circuit breaker.

Referring now to FIGS. 4A and 4B, illustrations of output signals of a solid-state circuit breaker in accordance with an exemplary embodiment of the present invention are shown. As shown in FIG. 4A, a forward-phase dimmer control algorithm may be utilized by a solid-state circuit breaker to generate output signal 404 based on the input signal 402. The forward-phase dimmer control algorithm is configured to selectively activate/deactivate the switching components when the input signal crosses a first-phase angle 406, a second-phase angle 408, and a third-phase angle 410. As shown in FIG. 4B, a reverse-phase dimmer control algorithm may be utilized by a solid-state circuit breaker to generate output signal 414 based on the input signal 412. The reverse-phase dimmer control algorithm is configured to selectively activate/deactivate the switching components when the input signal crosses a first-phase angle 416, a second-phase angle 418, and a third-phase angle 420.

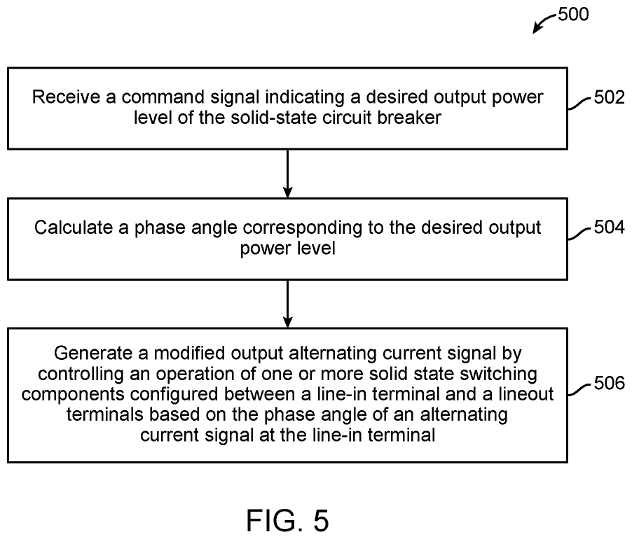

Referring now to FIG. 5, a flowchart of a method 500 for operating a solid-state circuit breaker in accordance with an exemplary embodiment of the present invention is shown. In exemplary embodiments, the method 500 is performed by a controller 130 of solid-state circuit breaker 105, as shown in FIG. 1. As shown at block 502, the method 500 includes receiving a command signal indicating a desired output power level of the solid-state circuit breaker. In exemplary embodiments, the command signal is received by a transceiver of the solid-state circuit breaker from a user device and is provided by the transceiver to a controller of the solid-state circuit breaker. Next, as shown at block 504, the method 500 includes calculating a phase angle corresponding to the desired output power level.

In exemplary embodiments, calculating the phase angle corresponding to the desired output power level includes obtaining a first phase angle corresponding to a cut-off output power level, obtaining a second phase angle corresponding to a full output power level, and interpolating the phase angle between the first phase angle and the second phase angle based on the cut-off output power level, the full output power level, and the desired output power level. In another embodiment, the controller of the solid-state circuit breaker includes a look-up table that is used to identify a phase angle corresponding to the desired output power level.

In one embodiment, the first phase angle corresponding to the cut-off output power level is stored in a memory of the solid-state circuit breaker and is determined based at least in part on input from the user device. In exemplary embodiments, the line-out terminal of the solid-state circuit breaker is connected to a load that includes one or more lighting devices and the cut-off output power level corresponds to a minimum power level that is sufficient to power on the one or more lighting devices. In one embodiment, a user device, such as a smartphone, is utilized by a user to set the cut-off output power level. For example, the controller may slowly reduce the power level provided to the lighting devices and an application on the user device may prompt the user to indicate when the lighting devices are turned off, thereby identifying the cut-off output power level.

Next, as shown at block 506, the method 500 includes generating a modified output alternating current signal by controlling an operation of one or more solid-state switching components configured between a line-in terminal and a line-out terminal based on the phase angle of an alternating current signal at the line-in terminal. In exemplary embodiments, controlling the operation of one or more solid-state switching components includes performing one of a forward-phase dimmer control and a reverse-phase dimmer control using the one or more solid-state switching components.

In exemplary embodiments, pulse modulation may be used to create an output signal, rather than phase angle lookup. For example, pulse modulation can be used to “chop” or pulse modulate the solid-state switching components (112-1 & 112-2) within each cycle of the current conduction lobes and to thereby rapidly turn on and off the lights at a frequency greater than the frequency of the input signal, (e.g., 60 Hz power cycle). Because the human eye cannot detect or see light flicker faster than 60 hz the controller 130 may instruct the solid-state switching components (112-1 & 112-2) to turn on/off the (112-1 & 112-2) output driver's gates at a faster frequency.

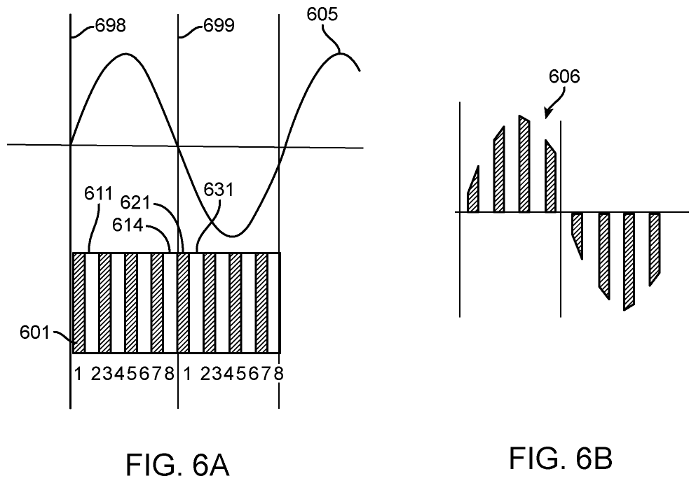

Referring now to FIGS. 6A and 6B, illustrations of an input signal 605 and an output signal 606 of a solid-state circuit breaker in accordance with an exemplary embodiment of the present invention are shown. In exemplary embodiments, calculating a duty cycle for the solid-state circuit breaker includes calculating a modulation frequency, an on-time for each pulse, and an off-tire for each pulse to create the desired output power level. In the illustrated embodiment, a switch rate of 480 Hz and “on/off” event every 0.00102 seconds using a 50% duty cycle may be used. In this embodiment, the 60 Hz period, or 16.333 mA cycle would equate to eight “on” pulses and eight “off” pulses in the sequence of on/off. In this embodiment, when the controller identifies a zero crossing 698, the controller sends an output signal pulse to turn on gate 112-1 for 0.001 seconds (601) and turn off for 0.001 seconds (611). The controller 130 would send this same pulse sequence to 112-1 and repeat three more times until the next zero cross 699 for which controller 130, for the negative current conduction lobe, would send pulse sequences to solid-state switching component 112-2 and would repeat the same combination turning on for 0.001 seconds (621) and off (631) for 0.001 seconds a total of four times thus completing the sixteen 0.00102 seconds pulses. As shown in this single modulation embodiment in FIGS. 6A and 6B, the indicator 601 pulse equals 1 mS ON 611 and 1 mS OFF (delay). In this embodiment, the 50% duty cycle describes a 601 pulse duration which is equal to the 611 pulse, or wait duration and could be varied to any unbalanced combination duty cycles (i.e., 60% to 40%) to gain or design the max efficiency relative to cooling or relative optimization combinations.

In this embodiment, a 1/480 hz period was chosen, but any combination that would produce light at a rate faster than the human eye could detect may be used. Furthermore, the controller 130 may also contain lookup tables to set the various duty cycles and or various modulation frequencies. In general, the use of pulse modulation allows the lighting loads to cool while producing useful lighting for human use with the added benefit of lengthening the life cycle of the solid-state switching components 112-1 and 112-2 due to minimizing the solid-state switching component's conduction times or minimizes their hours of operation and preserves their overall lifetime wattage exposure.

In exemplary embodiments, the lighting control methods disclosed herein can be used to improve lighting load efficiencies to extend the lighting load's life cycle and go beyond dimming lights to reduce the user's home energy bill by lowering the root mean square (RMS) value of the load power used. Because the gates of 112-1 and 112-2 solid-state switching components and outputs of controller 130 can be operated to turn on/off faster than 60 hz the disclosed lighting control system can be used to turn on/off faster or higher frequencies. Cooling or chopping combinations can be programmed to the highest frequencies of the solid-state switching components design limits and will increase with advances in silicon chip advancements and design in future improvements due to the solid-state switching component science. These combination configurations can be delivered to the user in a phone application like the phase-controlled dimmer method previously mentioned.

In exemplary embodiments, due to the vast varying types of lighting loads (e.g., LED lighting, large fluorescent lighting, compact fluorescent lighting, incandescent, or the like), and variations in original equipment manufacturers lighting designs, a look-up table, or fixed configurations may not be suitable for use in controlling the dimming any one of these combinations and varying lighting loads. One method for effectively controlling the dimming of such a vast variety of lighting loads is to use an application to train the solid-state circuit breaker 105 for each unique load (i.e., a combination of various lighting loads on a circuit connected to the solid-state circuit breaker 105).

In exemplary embodiments, after a user has connected a solid-state circuit breaker 105 to a circuit including a load 170 having one or more lighting devices, an application on a user device 212, that is communication with the solid-state circuit breaker 105 is used to place the solid-state circuit breaker 105 into a training or calibration mode. In exemplary embodiments, the controller 130 is configured to learn output power levels associated with various lighting levels automatically. For example, the controller 130 will vary the phase angle or duty cycle to create various output power levels and will receive either user input indicating the lighting level or sensor data from a camera of the user device that indicates a lighting level. The controller will utilize this feedback and continually adjust the output power level to learn the output power level that corresponds to each lighting level. In exemplary embodiments, the learned correspondence between the output power level and the lighting levels is stored in a look-up table, which is then used to identify the output power level for a user-provided desired lighting level. In exemplary embodiments, the solid-state circuit breaker 105 stores the look-up table that was created based on feedback from a user or user device, and the look-up table stores all the parameters used to create the desired dimmed light output intensity or energy goal.

In exemplary embodiments, after the solid-state circuit breaker 105 has been set up, an application on the user device 212 may be used to collect usage data from the solid-state circuit breaker 105 over time and to analyze the usage data. In one embodiment, the usage data includes on/off times and power output levels for the solid-state circuit breaker 105. In exemplary embodiments, the application may be configured to identify usage patterns of the solid-state circuit breaker 105 and may responsively create one or more schedules or routines that can be automatically applied to the solid-state circuit breaker 105. For example, the usage data may indicate that the solid-state circuit breaker 105 is normally operated at fifty percent between eight pm and ten pm and then turned off. In this case, the application may create an automatic routine to turn the solid-state circuit breaker 105 on, at a fifty percent power level, at eight pm and to turn the solid-state circuit breaker 105 off at ten pm. In some cases, if the user has indicated a desire to reduce power usage, the application may set the schedule to a forty percent power level rather than the fifty percent power level, to reduce power consumption.

In one embodiment, the controller 130 is configured to monitor changes made to the power output of the solid-state circuit breaker 105 and to report monitored data to an application on the user device 212. The controller 130 and/or the application on the user device 212 are configured to continuously learn and re-adjust the schedules and routines. For instance, when a lighting device in the load has reached its end-of-life cycle and is starting to shift in its original behavior, the application or controller 130 may detect this change based on the user adjusting the lighting level to increase the desired power output level.

The techniques described herein can be particularly useful for a different operating sequence of solid-state switching components and an air gap to open the air gap faster. While particular embodiments are described in terms of two operating sequences, the techniques described herein are not limited to such operating sequences but can also be used with other operating sequences.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1. A solid-state circuit breaker comprising:
a breaker housing;
a line-in terminal and a line-out terminal;
one or more solid-state switching components configured between the line-in terminal and the line-out terminal;
an air gap disposed between the line-in terminal and the line-out terminal and coupled in series with the one or more solid-state switching components to complete a current conducting path when closed, the air gap including a pair of opposing contacts and an air gap driving mechanism;
an air gap actuator to interact with the air gap driving mechanism;
a transceiver; and
a controller that controls the air gap actuator and the one or more solid-state switching components, wherein the controller is configured to receive a command signal and to responsively control the one or more solid-state switching components based on the command signal.

2. The solid-state circuit breaker of claim 1, wherein the command signal indicates a desired output power level of the solid-state circuit breaker.

3. The solid-state circuit breaker of claim 2, wherein the desired output power level is a percentage that ranges from zero to one hundred.

4. The solid-state circuit breaker of claim 1, wherein controlling the one or more solid-state switching components based on the command signal comprises selectively activating and deactivating the one or more solid-state switching components based on a phase angle of an alternating current signal at the line-in terminal.

5. The solid-state circuit breaker of claim 1, wherein a solid-state switching component of the one or more solid-state switching components is a metal-oxide-semiconductor field-effect transistor (MOSFET) or an insulated-gate bipolar transistor (IGBT) which has a reaction time and can switch off in about 1 microsecond or less after receiving a trigger signal from the controller.

6. The solid-state circuit breaker of claim 1, wherein the transceiver is configured to communicate using one or more of Bluetooth, Wi-Fi, and Zigbee.

7. The solid-state circuit breaker of claim 1, wherein the controller is further configured to selectively perform one of a forward-phase dimmer control and a reverse-phase dimmer control using the one or more solid-state switching components.

8. The solid-state circuit breaker of claim 1, wherein the controller is further configured to use pulse modulation to control the one or more solid-state switching components, wherein a duty cycle of the pulse modulation is based on the command signal.

9. A method for operating a solid-state circuit breaker, the method comprising:
receiving a command signal indicating a desired output power level of the solid-state circuit breaker;
calculating one of a phase angle and a duty cycle corresponding to the desired output power level; and
generating a modified output alternating current signal by controlling an operation of one or more solid-state switching components configured between a line-in terminal and a line-out terminal based on the one of the phase angle and the duty cycle of an alternating current signal at the line-in terminal,
wherein the command signal is received via a transceiver of the solid-state circuit breaker from a user device that is separate from the solid-state circuit breaker.

10. The method of claim 9, wherein the transceiver is configured to communicate with the user device using one or more of Bluetooth, Wi-Fi, and Zigbee.

11. The method of claim 9, wherein a solid-state switching component of the one or more solid-state switching components is a metal-oxide-semiconductor field-effect transistor (MOSFET) or an insulated-gate bipolar transistor (IGBT) which has a reaction time and can switch off in about 1 microsecond or less after receiving a trigger signal from a controller of the solid-state circuit breaker.

12. The method of claim 9, wherein the desired output power level is a percentage that ranges from zero to one hundred.

13. The method of claim 9, wherein calculating the phase angle corresponding to the desired output power level includes:
obtaining a first phase angle corresponding to a cut-off output power level;
obtaining a second phase angle corresponding to a full output power level; and
interpolating the phase angle between the first phase angle and the second phase angle based on the cut-off output power level, the full output power level, and the desired output power level.

14. The method of claim 13, wherein the first phase angle corresponding to the cut-off output power level is stored in a memory of the solid-state circuit breaker and is determined based at least in part on an input from the user device.

15. The method of claim 9, wherein calculating the duty cycle includes calculating a modulation frequency, an on time for each pulse, and an off time for each pulse to create the desired output power level.

16. A system comprising:
a solid-state circuit breaker comprising:
a line-in terminal and a line-out terminal;
one or more solid-state switching components configured between the line-in terminal and the line-oat terminal;
an air gap disposed between the line-in terminal and the line-out terminal and coupled in series with the one or more solid-state switching components to complete a current conducting path when closed, the air gap including a pair of opposing contacts and an air gap driving mechanism;
an air gap actuator to interact with the air gap driving mechanism;
a transceiver; and
a controller that controls the air gap actuator and the one or more solid-state switching components, wherein the controller is configured to receive a command signal and to responsively control the one or more solid-state switching components based on the command signal; and
a load that includes one or more lighting devices connected to the line-out terminal of the solid-state circuit breaker,
wherein the command signal is received from a user device that is in communication with the transceiver of the solid-state circuit breaker.

17. The system of claim 16, wherein controlling the one or more solid-state switching components based on the command signal comprises selectively activating and deactivating the one or more solid-state switching components based on a phase angle of an alternating current signal at the line-in terminal.

18. The system of claim 17, wherein the phase angle is calculated based on a desired output power level indicated by the command signal and wherein calculating the phase angle includes:
obtaining a first phase angle corresponding to a cut-off output power level;
obtaining a second phase angle corresponding to a full output power level; and
interpolating the phase angle between the first phase angle and the second phase angle based on the cut-off output power level, the full output power level, and the desired output power level.

19. The system of claim 18, wherein the first phase angle corresponding to the cut-off output power level is stored in a memory of the solid-state circuit breaker and is determined based at least in part on an input from the user device.

20. The system of claim 16, wherein the controller is further configured to use pulse modulation to control the one or more solid-state switching components, wherein a duty cycle of the pulse modulation is based on the command signal.
